(19) United States
(12) Patent Application Publication
(10) Pub. No.: US 2012/0291987 A1
(43) Pub. Date: Nov. 22, 2012

(54) SYSTEM FOR A MOTOR VEHICLE FOR HEATING AND/OR COOLING A BATTERY AND A VEHICLE INTERIOR

(76) Inventors: Thomas HIMMER, Reichenbach (DE); Markus WESNER, Stuttgart (DE)

(21) Appl. No.: 13/478,251

(22) Filed: May 23, 2012

Related U.S. Application Data
(63) Continuation of application No. PCT/EP2010/067948, filed on Nov. 22, 2010.

(30) Foreign Application Priority Data
Nov. 23, 2009 (DE) 10 2009 054 186.1

(51) Int. Cl. B60H 1/22; B60K 11/00; F28F 3/08; B60H 1/32

(52) U.S. Cl. 165/42; 62/524; 62/259.2; 165/140

(57) ABSTRACT

In a system for a motor vehicle for heating and/or cooling a battery and a motor-vehicle interior, comprising a coolant circuit which is coupled thermally to the battery, a refrigerating circuit with a condenser, a compressor, a first evaporator for cooling the motor-vehicle interior and a second evaporator for cooling the battery. The second evaporator is thermally coupled to the coolant circuit via an evaporator heat exchanger and a surrounding-air heat exchanger is coupled thermally to the coolant circuit for the transmission of waste heat of the battery to the surrounding air. The waste heat of the battery is used to heat the motor-vehicle interior. The evaporator heat exchanger is provided with at least one device for transmitting heat from the evaporator heat exchanger to the surrounding air and/or the motor-vehicle interior, for transmitting waste heat of the battery to the surrounding air and/or the motor-vehicle interior.

This nonprovisional application is a continuation of International Application No. PCT/EP2010/067948, which was filed on Nov. 22, 2010, and which claims priority to German Patent Application No. DE 10 2009 054 186.1, which was filed in Germany on Nov. 23, 2009, and which are both herein incorporated by reference.

### BACKGROUND OF THE INVENTION

1. Field of the Invention

The invention relates to a system for a motor vehicle for heating and/or cooling a battery and a vehicle interior, a heat exchanger, and a method for heating and/or cooling a battery and a vehicle interior.

2. Description of the Background Art

An electric heater for heating the air in the vehicle interior is generally necessary in hybrid vehicles with an internal combustion engine and an electric motor, as well as in electric vehicles that are powered solely by an electric motor. In hybrid vehicles with an internal combustion engine, the waste heat of the internal combustion engine is generally not sufficient to heat the vehicle interior. There is no internal combustion engine in electric vehicles, so that the heat for heating the vehicle interior air is provided solely by the electric heater.

The battery of the hybrid vehicle or electric car must be heated or cooled to maintain a sufficient battery operating temperature, for example, within a temperature range between 0° C. and 40° C. When electric power is drawn from the battery, the battery gives off heat, so that the battery must be cooled in order not to heat up to temperatures above 30° C. or 40° C. At low outside temperatures, which are, for example, below 0° C., heating of the battery is necessary, so that electric power can be drawn from the battery and charging with electric power is possible. To this end, the hybrid or electric vehicle has a coolant circuit by which the battery can be cooled, particularly cooled with ambient air.

DE 101 28 164 A1, which corresponds to U.S. Pat. No. 6,705,101, and which is incorporated herein by reference, presents a vehicle cooling system for an electric or hybrid vehicle. The vehicle cooling system has a coolant circuit which is thermally coupled to a battery. Further, an evaporator of a refrigeration circuit having a condenser, a compressor, and an expansion valve is built into the coolant circuit with the battery. The coolant circuit with the battery can be cooled by the evaporator, so that as a result, the battery can also be cooled by means of the refrigeration circuit. It is known in addition in a vehicle cooling system of this type to couple the coolant circuit for the battery to an ambient air heat exchanger, so that at low outside temperatures the battery can be cooled by giving off the heat to the ambient air, without the refrigeration circuit being in operation.

Disadvantageously, in the conventional art, the waste heat of the battery is not available for heating the vehicle interior and an additional ambient air heat exchanger is necessary.

DE 10 2008 017 113 A1 discloses an evaporator as a heat exchanger for a motor vehicle. A plurality of plates are stacked parallel to one another in the vertical direction as a heat exchanger in a plate or disk construction. A first flow chamber is formed between the plates for a refrigerant as the first fluid and a second flow chamber for a second fluid, so that heat can be transferred from the second fluid to the refrigerant.

### SUMMARY OF THE INVENTION

It is therefore an object of the present invention to provide a system for a motor vehicle for heating and/or cooling a battery and a vehicle interior, a heat exchanger, and a method, in which the battery waste heat can be utilized with low technical outlay to heat the vehicle interior.

This object is attained with a system for a motor vehicle for heating and/or cooling a battery and a vehicle interior, comprising a coolant circuit, which is thermally coupled to the battery, particularly to a battery-heat exchanger, a refrigeration circuit having a condenser, a compressor, a first evaporator for cooling the vehicle interior, and a second evaporator for cooling the battery, in that the second evaporator with an evaporator-heat exchanger is thermally coupled to the coolant circuit and preferably an ambient air heat exchanger, which is thermally coupled to the coolant circuit, for transferring the battery waste heat to the ambient air, whereby the evaporator-heat exchanger is provided with at least one device for transferring heat from the evaporator-heat exchanger to the ambient air and/or the vehicle interior in order to transfer battery waste heat to the ambient air and/or to the vehicle interior, particularly when the refrigeration circuit is turned off, and/or preferably the ambient air heat exchanger is provided with at least one device for transferring heat from the ambient air heat exchanger to the ambient air and/or the vehicle interior in order to transfer battery waste heat to the ambient air and/or the vehicle interior, particularly when the refrigeration circuit is turned off.

The waste heat given off by the battery can thus be given off either to the ambient air or to the vehicle interior, in that by the at least one device the waste heat can be given off from the evaporator-heat exchanger to the ambient air or to the air to be supplied to the vehicle interior. It is possible as a result that the battery waste heat can be used for heating the vehicle interior. The use of battery waste heat for heating the vehicle interior can also be realized in addition by heating the air, to be supplied to the vehicle interior, at the ambient air heat exchanger by the at least one device, which is present in addition also in the preferably present ambient air heat exchanger, before being supplied to the vehicle interior.

In particular, the at least one device comprises a fan and/or a housing with an air inlet and outlet opening and/or at least one air guiding device, particularly at least one air flap, and/or at least one air duct.

Expediently, the evaporator-heat exchanger and/or preferably the ambient air heat exchanger is surrounded by the housing, so that the air to be supplied to the vehicle interior is first passed through the space enclosed by the housing in which the evaporator heat exchanger is located, and as a result the air can be heated at the evaporator-heat exchanger.

In another embodiment, the evaporator-heat exchanger is designed with a disk construction.

In a supplementary embodiment, the evaporator-heat exchanger is designed as a heat exchanger described in this industrial property application.

Preferably, in regard to the heat exchanger the first fluid is the refrigerant of the refrigeration circuit, the second fluid is the coolant of the coolant circuit, and the third fluid is air, particularly the air to be supplied to the vehicle interior or air to be conveyed to the ambient air. The evaporator-heat exchanger is designed with the disk construction. To this end, the evaporator-heat exchanger has a first fluid channel for conducting the refrigerant and a second fluid channel for conducting the coolant of the coolant circuit. If the battery is to be cooled by means of the refrigeration circuit, a valve in the refrigeration circuit is opened, so that the refrigerant flows through the evaporator-heat exchanger and thereby the refrigerant takes up the heat from the coolant of the refrigeration circuit. When the refrigeration circuit is turned off, the battery can be cooled in addition and optionally the vehicle interior can be heated, in that air is conveyed to the heat exchanger, said air is heated at the heat exchanger, and then conveyed to the ambient air or into the vehicle interior. When the refrigeration circuit is turned off, i.e., that no refrigerant flows through the first fluid channel, thus heat can be transferred from the coolant in the second fluid channel to a third fluid, namely air, particularly to the air to be supplied to the vehicle interior.

In an embodiment, the air to be supplied to the vehicle interior can be heated at the evaporator-heat exchanger, particularly the heat exchanger.

The heat exchanger of the invention with a disk construction, comprising a plurality of disks stacked one above the other, so that a first fluid channel for a first fluid and a second fluid channel for a second fluid are formed between the disks, an inlet and outlet opening is provided for the first fluid and an inlet and outlet opening for the second fluid, whereby the heat exchanger is provided with corrugated fins for external temperature control, i.e., heating and/or cooling, for a third fluid at the heat exchanger and/or the heat exchanger is provided with openings, preferably slots, for conducting and controlling the temperature of the third fluid and/or the heat exchanger with a third fluid channel for conducting the third fluid, particularly air, through the heat exchanger. The heat exchanger can thereby be used advantageously not only to transfer heat from the first fluid to the second fluid and vice versa, but also to transfer heat from the first fluid and/or the second fluid to a third fluid and vice versa. This is possible because the heat exchanger is provided either with suitable corrugated fins on the outside or in addition has openings, so that the heat can also be transferred on a sufficient scale on the outside to the third fluid at the heat exchanger.

The corrugated fins can be arranged on the outside on a block of disks stacked one above the other and/or the corrugated fins are arranged between the disks.

In another embodiment, the disks are designed as flat plates.

The method of the invention for cooling and/or heating a battery of a motor vehicle and/or a vehicle interior with a refrigeration circuit having a condenser, a compressor, a first evaporator, and a second evaporator and having a coolant circuit, which is thermally coupled to the battery, in that to cool the battery, heat is transferred from the battery by means of the coolant circuit to the second evaporator by means of an evaporator-heat exchanger and to cool the vehicle interior, air is cooled at the first evaporator, and preferably by means of an ambient air heat exchanger, heat is taken away from the coolant circuit to the ambient air for cooling the battery, particularly by means of the system described in this industrial property application, whereby air is heated at the evaporator-heat exchanger air when the refrigeration circuit is turned off and the heated air is supplied to the vehicle interior and/or the ambient air and preferably air is heated at the ambient air heat exchanger when the refrigeration circuit is turned off and the heated air is supplied to the vehicle interior and/or the ambient air.

In particular, air is passed over and/or through the evaporator-heat exchanger.

In another embodiment, the air after the heating at the evaporator-heat exchanger is supplied to the vehicle interior and/or conveyed to the ambient air of the motor vehicle.

In an embodiment, air is passed over and/or through the evaporator-heat exchanger by a fan or by means of convection.

In another embodiment, air is heated at the evaporator-heat exchanger by an electric heater, particularly a PTC heater, before, after, or during its passing over the evaporator-heat exchanger.

A vehicle HVAC system of the invention comprises a system described in this industrial property application and/or the vehicle HVAC system comprises a heat exchanger described in this industrial property application and/or the vehicle HVAC system is capable of carrying out the method described in this industrial property application.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a highly schematized illustration of a system in a first exemplary embodiment for a motor vehicle for heating and/or cooling a battery and a vehicle interior;

FIG. 2 is a highly schematized illustration of the system in a second exemplary embodiment for a motor vehicle for heating and/or cooling the battery and the vehicle interior;

FIG. 3 is a perspective view of a heat exchanger in a first exemplary embodiment;

FIG. 4 is a front view of the heat exchanger according to FIG. 3;

FIG. 5 is a perspective view of the heat exchanger in a second exemplary embodiment;

FIG. 6 is a perspective view of the heat exchanger in a third exemplary embodiment;

FIG. 7 is a sectional view of the heat exchanger according to FIG. 6;

FIG. 8 is a perspective view of the heat exchanger in a fourth exemplary embodiment;

FIG. 9 is a sectional view of the heat exchanger in a fifth exemplary embodiment;

FIG. 10 is a sectional view of the heat exchanger in a sixth exemplary embodiment; and

FIG. 11 is a simplified illustration of the heat exchanger according to FIGS. 3 to 5, 8 and 10 in a housing.

### DETAILED DESCRIPTION

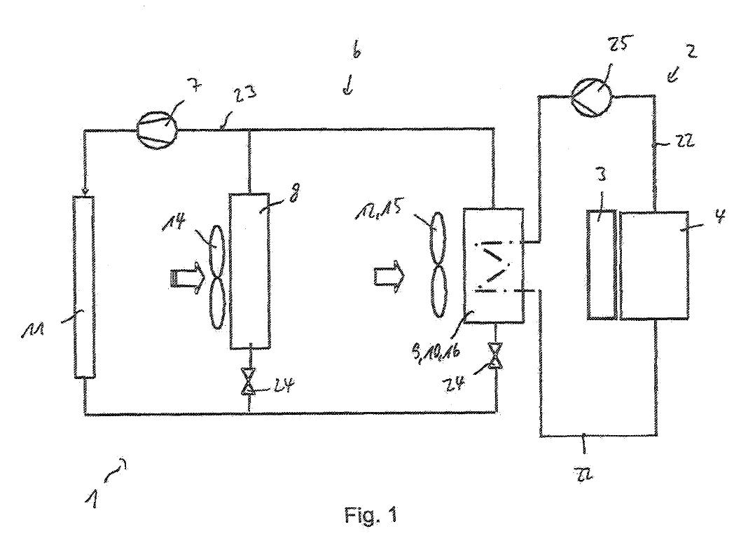

A system 1 for a motor vehicle for heating and cooling a battery 3 and a vehicle interior is shown in FIG. 1. Battery 3 is used in this case to power the motor vehicle as a traction battery. System 1 has a coolant circuit 2 with lines 22, through which water with an antifreeze is circulated by a circulation pump 25 as the coolant. First coolant circuit 2 in this regard is thermally coupled to a battery-heat exchanger 4 with battery 3. To cool or heat battery 3, air which is heated or cooled in battery-heat exchanger 4 is circulated around battery 3.

System 1 comprises further a refrigeration circuit 6 having a compressor 7, a condenser 11, a first evaporator 8, and a second evaporator 9. Refrigerant flows through refrigeration circuit 6 through lines 23 of refrigeration circuit 6. A first fan 14 is arranged at first evaporator 8. Air can be conveyed from the environment or from the vehicle interior in the air circulation by means of first fan 14 to first evaporator 8, so that in refrigeration circuit 6 during operation the air is cooled in first evaporator 8 and then this cooled air is supplied to the vehicle interior (not shown). The heat removed from the air in first evaporator 8 is thereby released into the motor vehicle environment at condenser 11. Further, two valves 24 are arranged in refrigeration circuit 6. Valves 24 can be used to control whether the refrigerant flows only through first evaporator 8, only through second evaporator 9, or through both evaporators 8, 9 and thereby a fluid can be cooled in first and/or second evaporator 8, 9. Second evaporator 9 represents an evaporator-heat exchanger 10 and is designed so that heat can be transferred by means of evaporator-heat exchanger 10 from the coolant in coolant circuit 2 to the refrigerant of refrigeration circuit 6. It is possible thereby that battery 3 can be cooled by refrigeration circuit 6 by means of second evaporator 9 or evaporator-heat exchanger 10. Sufficient cooling of battery 3 should be assured at high outside temperatures in the summer. To this end, refrigeration circuit 6 is put into operation and battery 3 can be cooled by means of refrigeration circuit 6 and evaporator-heat exchanger 10 when a valve 24 is opened at evaporator-heat exchanger 10. Evaporator-heat exchanger 10 therefore also represents a chiller.

A second fan 15 is arranged in addition at evaporator-heat exchanger 10. Air can be conveyed to evaporator-heat exchanger 10 by means of second fan 15 and this air is then supplied to the vehicle interior. At low outside temperatures in winter, for example, at outside temperatures of 0° C., operation of refrigeration circuit 6 is not necessary to cool battery 3, because the outside air temperatures are much lower than the set temperature of battery 3. To cool battery 3, the energy for operating compressor 7 can therefore be saved. Evaporator-heat exchanger 10 has a sufficiently large surface on the outside, so that because air is passed over evaporator-heat exchanger 10, the heat from the coolant of coolant circuit 2 can be given off also to a sufficient extent to the air drawn in from the environment and then supplied to the vehicle interior.

System 1 therefore advantageously does not require an additional ambient air heat exchanger 29, which is used only to give off the heat from coolant circuit 2 to the environment at low outside temperatures. In an advantageous manner, evaporator-heat exchanger 10 can be used for this purpose. Because of the air passed over evaporator-heat exchanger 10 as a chiller and the subsequent introduction into the interior of the motor vehicle, the waste heat from battery 3 can be used in addition to heat the vehicle interior, so that advantageously energy for heating the vehicle interior can be saved especially in hybrid or electric vehicles (not shown). If there is no need to heat the vehicle interior and the temperatures in the vehicle environment are sufficiently low to cool battery 3, the air passed over evaporator-heat exchanger 10 can be conveyed away not into the vehicle interior, but into the vehicle environment by means of an air guiding device (not shown), e.g., an air flap. It is also possible thereby to cool battery 3 by means of the ambient air without the vehicle interior being heated.

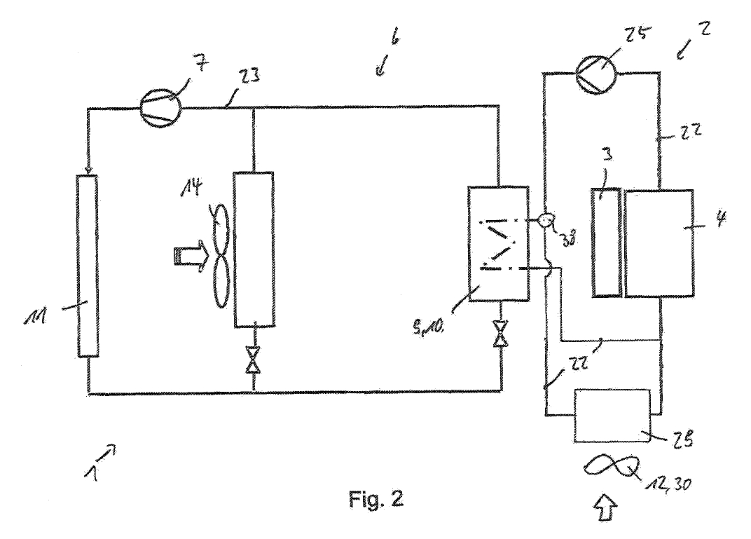

In another exemplary embodiment shown in FIG. 2, system 1 has in coolant circuit 2, apart from evaporator-heat exchanger 10, an additional ambient air heat exchanger 29, through which the coolant of coolant circuit 2 flows and through which air is conveyed by means of an additional fan 30. The transfer of the waste heat from battery 3 when refrigeration circuit 6 is turned on in the summer is thereby carried out by evaporator-heat exchanger 10 and the transfer at low outside temperatures when refrigeration circuit 6 is turned off is carried by the additional ambient air heat exchanger 29. A 3-way valve 38 controls whether the coolant flows only through evaporator-heat exchanger 10, only through ambient air heat exchanger 29, or through evaporator-heat exchanger 10 and ambient air heat exchanger 29. Otherwise, this exemplary embodiment corresponds substantially to the first exemplary embodiment according to FIG. 1.

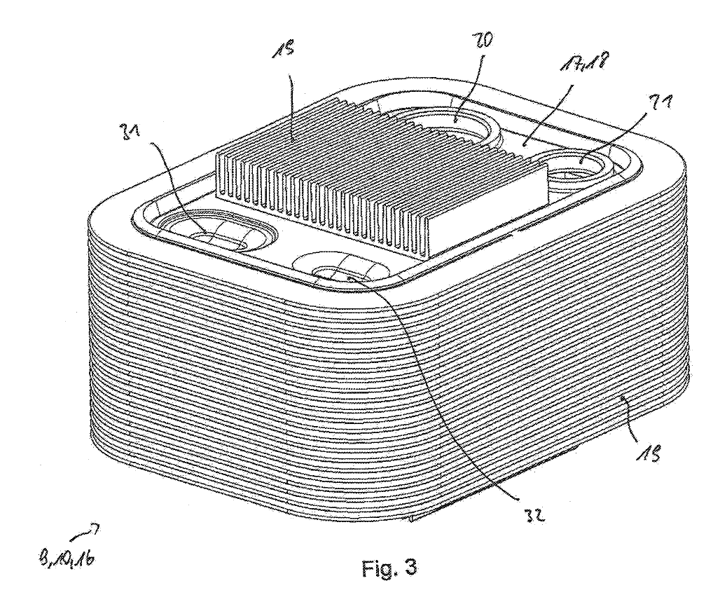

Exemplary embodiments of heat exchanger 16 are shown in FIGS. 3 to 10. Heat exchanger 16 corresponds in this case to evaporator-heat exchanger 10 of system 1 according to FIG. 1.

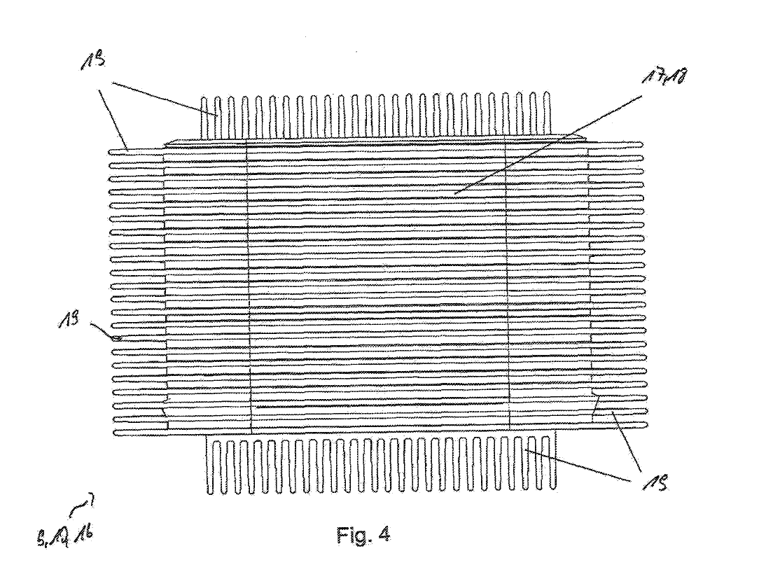

Heat exchanger 16 shown in FIGS. 3 and 4 in a first exemplary embodiment has a plurality of disks 17 arranged one above the other, so that they form a block 18. A first fluid channel 35 forms here between disks 17 for conducting the refrigerant of refrigeration circuit 6 and a second fluid channel 36 for conducting the coolant of coolant circuit 2. For this reason, the heat can be transferred from the coolant of coolant circuit 2 to the refrigerant of refrigeration circuit 6 and thus battery 3 can be cooled during summer operation. Heat exchanger 16 shown in FIGS. 3 and 4 in this regard has corrugated fins 19 on the outside on block 18 with disks 17, so that as a result the outer surface of heat exchanger 16 is increased and the air passed over heat exchanger 16 by means of second fan 15 at low temperatures in the winter can take up heat to a sufficiently great extent from the coolant of coolant circuit 2. The coolant is introduced through an inlet opening 20 into heat exchanger 16 and the coolant is discharged from an outlet opening 21. The refrigerant is introduced through an inlet opening 31 into heat exchanger 16 and the refrigerant is discharged from an outlet opening 32.

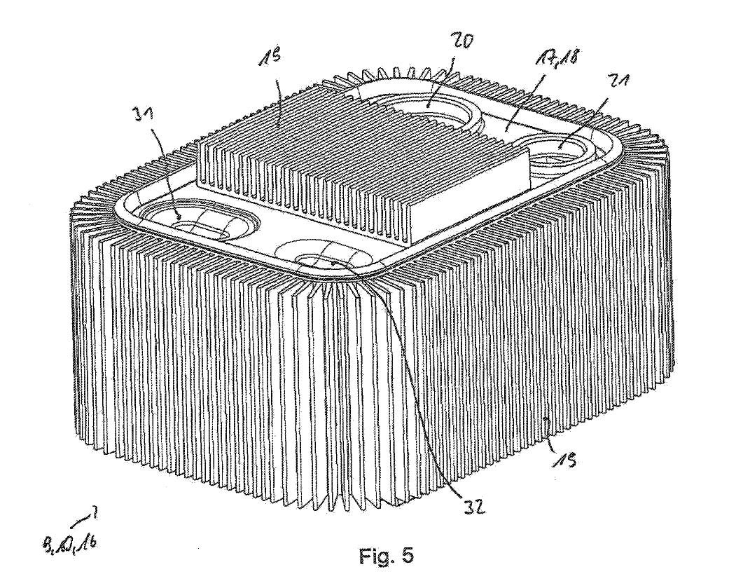

The second exemplary embodiment of heat exchanger 16 as shown in FIG. 5 differs from the first exemplary embodiment only in the different orientation of the laterally arranged corrugated fins 19.

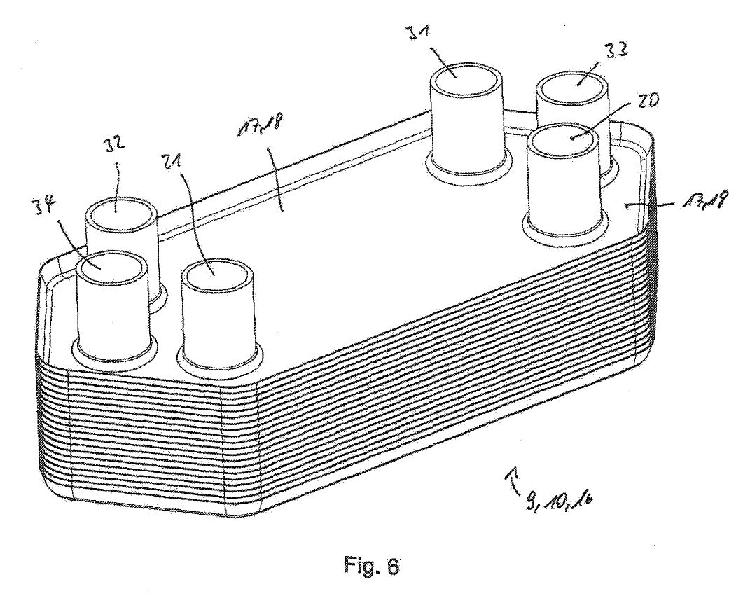

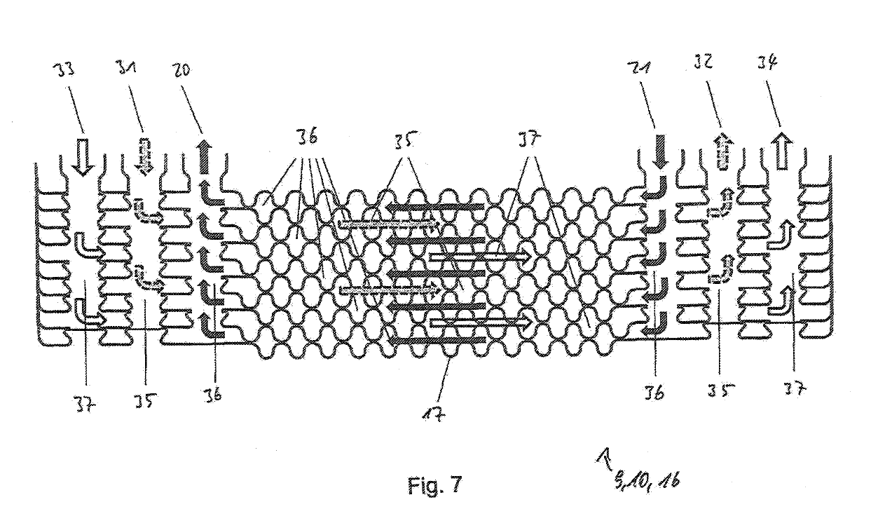

A third exemplary embodiment of heat exchanger 16 is shown in FIG. 6. A plurality of disks 17 are arranged one above the other to form block 18, so that a first fluid channel 35 for conducting the refrigerant of refrigeration circuit 6, a second fluid channel 36 for conducting the coolant of coolant circuit 2, and a third fluid channel 37 for conveying air are formed between the disks (FIG. 7). The flow guidance is shown in FIG. 7. For this reason, the heat can be transferred from the coolant of coolant circuit 2 to the refrigerant of refrigeration circuit 6 and thus during summer operation battery 3 can be cooled and in the winter the heat can be transferred from the coolant to the air. Coolant is introduced into heat exchanger 16 through inlet opening 20 and the coolant is discharged from outlet opening 21. The refrigerant is introduced into heat exchanger 16 through inlet opening 31 and the refrigerant is discharged through outlet opening 32 (summer) or air is introduced into heat exchanger 16 through an inlet opening 33 and air is discharged from an outlet opening 34 (winter). Instead of passing the air over the exchanger as in the first exemplary embodiment, therefore, in the third exemplary embodiment the air is conveyed through heat exchanger 16.

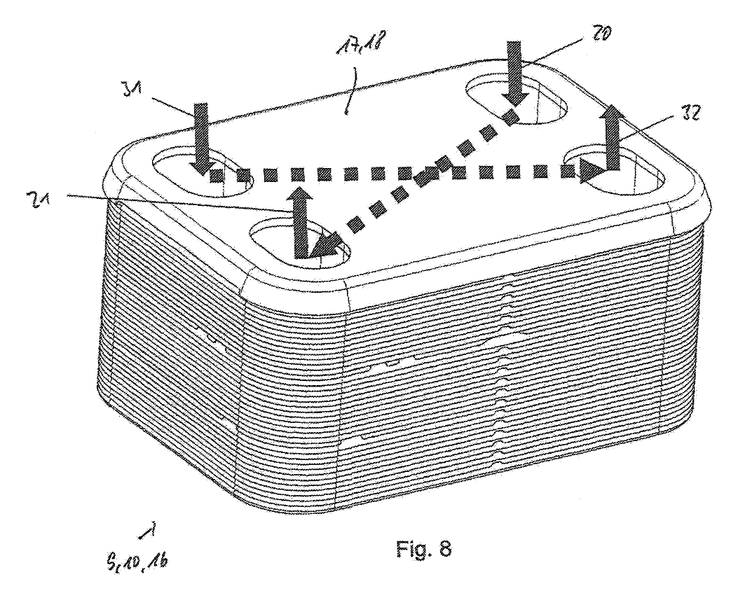

A fourth exemplary embodiment of heat exchanger 16, whose corrugated fins 19 are not shown, is illustrated in FIG. 8. Inlet and outlet opening 20, 21 for the coolant and inlet and outlet opening 31, 32 for the refrigerant are arranged diagonally in this case, so that the coolant and the refrigerant flow diagonally through heat exchanger 16 in the first and second fluid channel 35, 36.

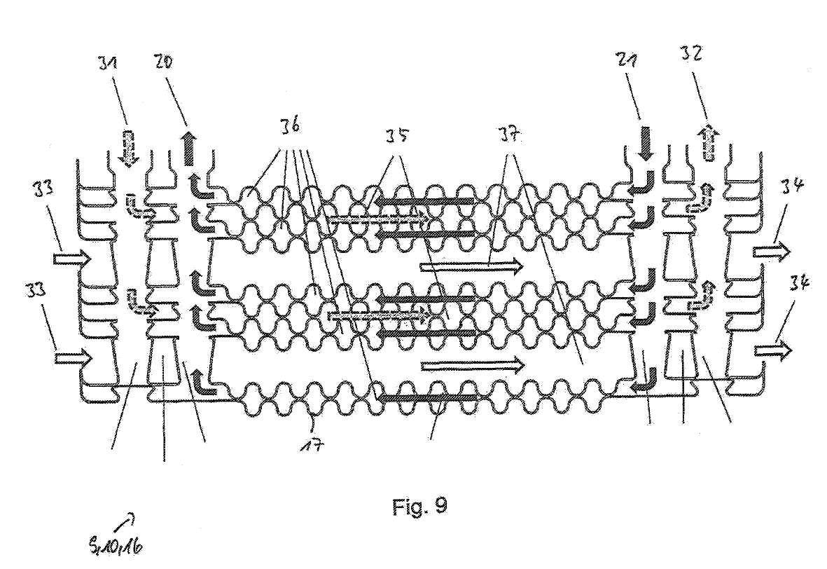

FIG. 9 shows a sectional view of heat exchanger 16 in a fifth exemplary embodiment. Inlet and outlet opening 20, 21 for the coolant and inlet and outlet opening 31, 32 for the refrigerant are arranged at the top and first and second fluid channel 35, 36 are each formed between disks 17. Third fluid channel 37 for air is formed between a number of disks 17 and the air flows in laterally through inlet openings 33 for the air and flows out laterally through outlet openings 34.

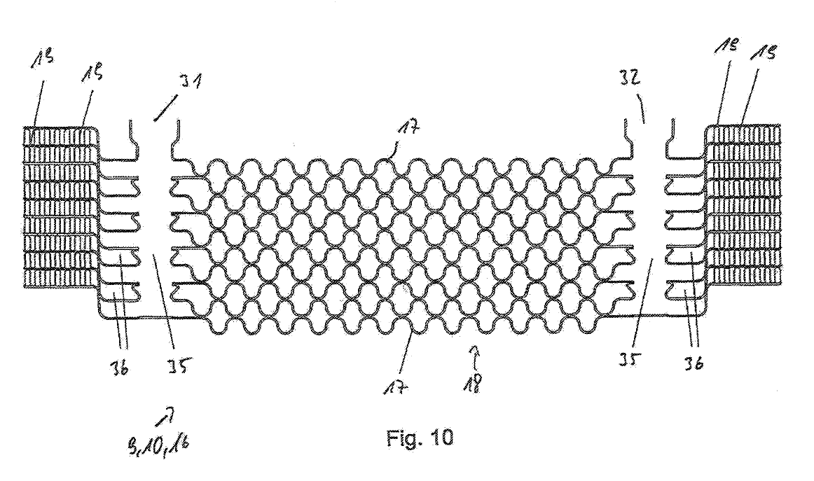

A sectional view of heat exchanger 16 in a sixth exemplary embodiment is shown in FIG. 10. Inlet and outlet openings 31, 32 for the refrigerant are formed at the top; this also applies to inlet and outlet opening 20, 21 (not shown) for the coolant. Corrugated fins 19 are present laterally at disk 17 arranged one above the other to form block 18. To cool the coolant, therefore, air flows around heat exchanger 16 on the outside and the heat is transferred from the coolant to the air (winter) by means of corrugated fins 19, provided the coolant is not cooled by the refrigerant

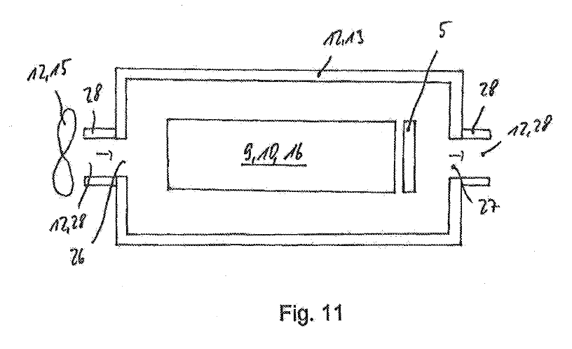

Evaporator-heat exchanger 10 shown in FIGS. 3 to 5, 8 and 10 as heat exchanger 16 with a disk construction is preferably arranged within a housing 13 (FIG. 11). Housing 13 in this case has an air inlet opening 26 and an air outlet opening 27, each of which opens into an air duct 28. Second fan 15 is arranged in the area of air inlet opening 26 as a device 12 for transferring heat from heat exchanger 16 or evaporator-heat exchanger 10 to the air to be supplied to the vehicle interior. An electric heater 5 is arranged within housing 13 apart from evaporator-heat exchanger 10. If the waste heat from battery 3 is not sufficient for heating the vehicle interior to the desired set temperature, the air can be heated in addition by means of an electric heater 5.

Viewed overall, major advantages are associated with system 1 of the invention and the method of the invention. Heat exchanger 16 or evaporator-heat exchanger 10 as a chiller in this regard is formed based on the arrangement of corrugated fins 19 to the effect that it has a sufficiently large surface on the outside, so that the heat can be given off from coolant circuit 2 not only to the refrigerant of refrigeration circuit 6 during summer operation, but also to a sufficient extent to the air passed over heat exchanger 16 by means of second fan 15. In this way, the additional ambient air heat exchanger 29 can be economized and in addition because of the utilization of the waste heat of battery 3 for heating the vehicle interior, electrical energy or energy for heating the vehicle interior can be saved. This is advantageous particularly in hybrid or electric vehicles, because batteries 3 of the hybrid or electric vehicle have a low energy storage capacity.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system for a motor vehicle for heating and/or cooling a battery and a vehicle interior, the system comprising:
a coolant circuit, which is thermally coupled to the battery;
a refrigeration circuit having a condenser, a compressor, a first evaporator for cooling the vehicle interior, and a second evaporator for cooling the battery, the second evaporator having an evaporator-heat exchanger that is thermally coupled to the coolant circuit;
an ambient air heat exchanger thermally coupled to the coolant circuit for transferring waste heat of the battery to the ambient air;
at least one device for transferring heat from the evaporator-heat exchanger to the ambient air and/or the vehicle interior in order to transfer the waste heat of the battery to the ambient air and/or to the vehicle interior when the refrigeration circuit is turned off, and/or at least one device for transferring heat from the ambient air heat exchanger to the ambient air and/or to the vehicle interior in order to transfer the waste heat of the battery to the ambient air and/or the vehicle interior when the refrigeration circuit is turned off.

2. The system according to claim 1, wherein the at least one device comprises a fan and/or a housing with an air inlet or an outlet opening and/or at least one air guiding device, particularly at least one air flap, and/or at least one air duct.

3. The system according to claim 1, wherein the evaporator-heat exchanger is designed with a disk construction.

4. The system according to claim 1, wherein the evaporator-heat exchanger is designed as a heat exchanger comprising:
a plurality of disks stacked one above the other, so that a first fluid channel for a first fluid and a second fluid channel for a second fluid are formed between the disks;
an inlet and outlet opening for the first fluid;
an inlet and outlet opening for the second fluid; and
corrugated fins for external temperature control of a third fluid at the heat exchanger and/or openings or slots for conducting and controlling the temperature of the third fluid and/or a third fluid channel for conducting the third fluid.

5. The system according to claim 4, wherein the first fluid is a refrigerant of the refrigeration circuit, the second fluid is a coolant of the coolant circuit, and the third fluid is air, particularly the air to be supplied to the vehicle interior.

6. The system according to claim 1, wherein the air to be supplied to the vehicle interior is heated at the evaporator-heat exchanger.

7. A heat exchanger having a disk construction, the heat exchanger comprising:
a plurality of disks stacked one above the other, so that a first fluid channel for a first fluid and a second fluid channel for a second fluid are formed between the disks;
an inlet and outlet opening for the first fluid;
an inlet and outlet opening for the second fluid; and
corrugated fins for external temperature control of a third fluid at the heat exchanger and/or openings or slots for conducting and controlling the temperature of the third fluid and/or a third fluid channel for conducting the third fluid.

8. The heat exchanger according to claim 7, wherein the corrugated fins are arranged on an outside on a block of the disks stacked one above the other and/or the corrugated fins are arranged between the disks.

9. The heat exchanger according to claim 7, wherein the disks are flat plates.

10. A method for cooling and/or heating a battery of a motor vehicle and/or a vehicle interior, the motor vehicle having a refrigeration circuit having a condenser, a compressor, a first evaporator, and a second evaporator and a coolant circuit that is thermally coupled to the battery, the method comprising:
transferring heat from the battery to cool the battery via the coolant circuit to the second evaporator via an evaporator-heat exchanger;
cooling air to cool the vehicle interior at the first evaporator;
taking heat away from the coolant circuit to the ambient air for cooling the battery via an ambient air heat exchanger; and
heating air at the evaporator-heat exchanger when the refrigeration circuit is turned off and the heated air is supplied to the vehicle interior and/or the ambient air and air is heated at the ambient air heat exchanger when a refrigeration circuit is turned off and the heated air is supplied to the vehicle interior and/or the ambient air.

11. The method according to claim 10, wherein air is passed over and/or through the evaporator-heat exchanger.

12. The method according to claim 10, wherein the air after heating at the evaporator-heat exchanger is supplied to the vehicle interior and/or conveyed to the ambient air of the motor vehicle.

13. The method according to claim 10, wherein air is passed over or through the evaporator-heat exchanger by a fan or via convection.

14. The method according to claim 10, wherein air heated is heated at the evaporator-heat exchanger by an electric heater, particularly a PTC heater, before, after, or during its passing over the evaporator-heat exchanger.

15. A vehicle HVAC system, wherein the vehicle HVAC system comprises:
a system according to claim 1; and
a heat exchanger comprising:
a plurality of disks stacked one above the other, so that a first fluid channel for a first fluid and a second fluid channel for a second fluid are formed between the disks;
an inlet and outlet opening for the first fluid;
an inlet and outlet opening for the second fluid; and
corrugated fins for external temperature control of a third fluid at the heat exchanger and/or openings or slots for conducting and controlling the temperature of the third fluid and/or a third fluid channel for conducting the third fluid

16. The system according to claim 1, wherein the coolant circuit is thermally coupled to a battery-heat exchanger.

17. The heat exchanger according to claim 1, wherein the third fluid is air.
